(19) United States
(12) Patent Application Publication
(10) Pub. No.: US 2019/0257256 A1
(43) Pub. Date: Aug. 22, 2019

(54) SYSTEM AND METHOD FOR IMPROVING HEAT RELEASE EVALUATION AT A RECIPROCATING INTERNAL COMBUSTION ENGINE

(71) Applicant: Scania CV AB, Södertälje (SE)

(72) Inventors: Ola STENLÅÅS, Södertälje (SE); Ivan Angarius WEST, Bromma (SE); Ola JÖNSSON, Huddinge (SE); Fredrik HASLESTAD, Rönninge (SE); Carlos JORGUES MORENO, Södertälje (SE)

(73) Assignee: Scania CV AB, Södertälje (SE)

(21) Appl. No.: 16/307,873

(22) PCT Filed: Jun. 7, 2017
(86) PCT No.: PCT/SE2017/050602

§ 371 Date: Dec. 6, 2018

(30) Foreign Application Priority Data
Jun. 15, 2016 (SE) 1650841-8

(51) Int. Cl. F02D 41/00; F02D 41/14; F02D 41/24; G01M 15/04

(52) U.S. Cl. CPC F02D 41/009; F02D 41/0097; F02D 41/1462; F02D 41/1467; F02D 41/2474; F02D 2200/023; G01M 15/042; F02D 2041/1433; F02D 2200/022; F02D 2200/101; F02D 41/1401

(57) ABSTRACT

Disclosed is a method, system, vehicle, and computer program for improving heat release evaluation at a reciprocating combustion engine. The method comprises providing a model regarding volume deviations in the combustion chamber based on a first set of dynamic parameters of the combustion engine. Said model comprises volume deviations due to thermal changes, due to mass forces and due to pressure forces. The method comprises determining the first set of dynamic parameters relating to the combustion engine, and determining the volume deviation in the combustion chamber based on said provided model and based on said first set of determined dynamic parameters. The method comprises providing an adaption model for the combustion engine based on said determined volume deviation in the combustion chamber, and adapting the combustion engine control and/or a diagnostic system of the combustion engine based on said adaption model so that said heat release evaluation is improved.

### CROSS-REFERENCE TO RELATED APPLICATIONS

This application is a national stage application (filed under 35 § U.S.C. 371) of PCT/SE2017/050602, filed Jun. 7, 2017 of the same title, which, in turn, claims priority to Swedish Application No. 1650841-8 filed Jun. 15, 2016; the contents of each of which are hereby incorporated by reference.

### FIELD OF THE INVENTION

The present disclosure relates to a system and a method for improving heat release evaluation at a reciprocating internal combustion engine. The present disclosure further relates to a vehicle, a computer program, and a computer program product.

### BACKGROUND OF THE INVENTION

In vehicles closed loop combustion control, CLCC, is used for adapting the combustion engine. This is especially useful for improving the possibility of the combustion engine to reduce its emissions, and to keep or improve its efficiency, especially under circumstances such as changing quality of the fuel which is supplied to the combustion engine. An important part in CLCC is heat release evaluation, HR. For performing HR it is important to know a set of parameters relating to the combustion engine. Mistakes or uncertainties in determining these parameters will in general lead to mistakes or uncertainties in the HR. It is thus important to know or to determine these parameters as accurate as possible. On the other hand, it is often too cumbersome and too expensive, or sometimes even impossible, to measure all parameters with high accuracy. Therefore it is inevitable to do some assumptions, averaging, simplifications, or similar actions when determining the parameters, or when performing HR. As an example, it is often assumed that components of the combustion engine have a geometrical shape according to their specification. It is known that individual parts may deviate slightly from the specification due to production tolerances, but the actual shape of individual parts inside their production tolerance is usually not measured.

### SUMMARY OF THE INVENTION

One often performed assumption is that the volume of a given combustion chamber is changing over time solely depending on the position of the piston in the cylinder of the combustion chamber, and that the position of the piston in the cylinder in a given geometrical arrangement is changing solely dependent on the crank angle degree. Experimental analysis, however, revealed that this assumption is not justifiable, especially not for bigger combustion engines, such as combustion engines for trucks. For a given truck combustion engine it turned out that the actual volume can deviate more than eight percent from the volume calculated by the above described assumption. Since the HR is highly dependent on the volume of the combustion chamber, it is advantageous to determine the actual volume more properly,

It is an objective of the present disclosure to provide a more accurate method for heat release evaluation at a reciprocating combustion engine. It is further an objective to provide a more advantageous method for heat release evaluation. It is yet even further an objective to provide an alternative method for heat release evaluation.

It is further an objective of the present disclosure to provide a system, a vehicle, a computer program, and a computer program product to utilise that method.

At least one of the objectives is achieved by a method for improving heat release evaluation at a reciprocating internal combustion engine. The method comprises providing a model regarding volume deviations in at least one combustion chamber based on a first set of dynamic parameters of the combustion engine. Said model comprises volume deviations due to thermal changes, due to mass forces and due to pressure forces. Said method further comprises determining the first set of dynamic parameters relating to the combustion engine and determining the volume deviation in said at least one combustion chamber based on said provided model and based on said first set of determined dynamic parameters. The method even further comprises providing an adaption model for the combustion engine. Said adaption model is based on said determined volume deviation in said at least one combustion chamber. The method yet even further comprises adapting the combustion engine control and/or a diagnostic system of the combustion engine based on said adaption model so that said heat release evaluation is improved.

In the present disclosure, when referring to a model based on a parameter, or based on something else, the term “based on” should be treated as that the model is a function of that parameter, or that something else.

Such a method allows adapting engine control to volume deviations from the ideal volume in said at least one combustion chamber. This allows to better control the engine and thus improves reducing fuel consumption and/or optimizing the composition of the exhaust. It also allows for compensation of individual production tolerances of a combustion engine without the need to measure the exact dimension of the individual components. Thus a more accurate control can be achieved without the need to perform time- and work-consuming measurements.

According to one example said provided model regarding volume deviations in said at least one combustion chamber also comprises volume deviations due to the deformation of a cylinder head of said reciprocating combustion engine. This further improves the model and thus a results in an even more accurate control.

According to one example said improving of the heat release evaluation relates to adapting at least one parameter related to said heat release evaluation. This allows improving existing heat release evaluations without the need to re-program all the methods used in these evaluations.

According to one example said first set of dynamic parameters comprises at least one out of the following quantities: crank angle degree, rotary speed of a crankshaft connected to the combustion engine, temperature of the crankshaft, temperature of at least one connecting rod connected to said crankshaft, temperature of at least one piston connected to said at least one connecting rod, temperature of a cylinder block in the combustion engine, temperature of a cylinder head in the combustion engine, pressure inside said at least one combustion chamber. This allows to provide a model based on real physical properties.

In the following, the shorthand notation conrod will be used instead of connecting rod. No different meaning is intended.

According to one example said adaption model comprises a relation how the volume deviation relates to at least a second set of dynamic parameters.

According to one example said second set of dynamic parameters comprises at least one out of the following quantities: a pressure inside said at least one combustion chamber, a temperature of a medium and/or an element, such as temperature of a lubricant and/or oil, temperature of at least one cylinder liner of the combustion engine, temperature of the crankshaft, temperature of said at least one conrod, temperature of said at least one piston, crank angle degree, rotary speed of the crankshaft, gas composition in said at least one combustion chamber, whether an inlet valve to a cylinder of the combustion engine is open or closed, whether an exhaust valve to a cylinder of the combustion engine is open or closed. This allows for an easy understandable adaption.

According to one example said adapting of the combustion engine control and/or of the diagnostic system of the combustion engine is performed at at least one pre-determined crankshaft angle and/or at at least one crankshaft angle interval. This improves the adaption process.

According to one example said adapting of the combustion engine control and/or of the diagnostic system of the combustion engine comprises adaption of at least one out of the following quantities: heat capacity ratio of the gas in said at least one combustion chamber, compression ratio at said combustion engine, sensitivity of a sensor, such as a pressure sensor for measuring the pressure in said at least one combustion chamber and/or such as a knock/acceleration sensor used to determine the pressure in said at least one combustion chamber. This provides for an easy implementable adaption.

According to one example said adapting of the combustion engine control and/or of the diagnostic system of the combustion engine comprises adapting at least one quantity such as the heat capacity ratio of the gas in said at least one combustion chamber, the compression ratio at said combustion engine, or the sensitivity of a sensor, such as a pressure sensor for measuring the pressure in said at least one combustion chamber and/or such as a knock/acceleration sensor used to determine the pressure in said at least one combustion chamber, for compensating by said at least one quantity for production tolerances of at least one component of the combustion engine, and/or for compensating by said at least one quantity for wear of at least one component of the combustion engine, and/or by compensating by said at least one quantity for the fuel quality of at least one fuel supplied to the combustion engine. This also provides for an easy implementable adaption.

According to one example said adapting of the combustion engine control and/or of the diagnostic system of the combustion engine comprises adapting at least one maximum volume deviation in said at least one combustion chamber. This provides for an especially good adaption.

According to one example said method is performed in real time. This allows reacting on changes relating to the combustion engine as they occur.

According to one example said adaption of the combustion engine control and/or the diagnostic system of the combustion engine comprises adapting at least one parameter in a particulate matter and/or NOx estimation method for the combustion engine. This especially allows reducing unwanted emissions.

At least one of the objectives is also achieved by a system for improving heat release evaluation at a reciprocating internal combustion engine. The system comprises means for providing a model regarding volume deviations in said at least one combustion chamber based on a first set of dynamic parameters of the combustion engine, wherein said model comprises volume deviations due to thermal changes, due to mass forces and due to pressure forces. Said system further comprises means for determining the first set of dynamic parameters relating to the combustion engine. Said system even further comprises means for determining the volume deviation in said at least one combustion chamber based on said provided model and based on said first set of determined dynamic parameters. Said system yet even further comprises means for providing an adaption model for the combustion engine, wherein said adaption model is based on said determined volume deviation in said at least one combustion chamber. Said system also comprises means for adapting the combustion engine control and/or a diagnostic system of the combustion engine based on said adaption model so that said heat release evaluation is improved.

According to one embodiment said means for adapting the combustion engine control and/or a diagnostic system of the combustion engine are arranged for adapting at least one parameter related to said heat release evaluation. In one example, adapting the combustion engine control and/or a diagnostic system of the combustion engine based on said adaption model so that said heat release evaluation is improved relates to that said means for adapting the combustion engine control and/or a diagnostic system of the combustion engine are arranged for adapting at least one parameter related to said heat release evaluation.

According to one embodiment said means for determining the first set of dynamic parameters comprises at least one out of the following means: means for determining a crank angle degree, means for determining a rotary speed of a crankshaft connected to the combustion engine, means for determining the temperature of the crankshaft, means for determining the temperature of a at least one conrod connected to said crankshaft, means for determining the temperature of at least one piston connected to said at least one conrod, means for determining the temperature of at least one cylinder liner, means for determining the temperature of a cylinder block in the combustion engine, means for determining the temperature of a cylinder head in the combustion engine, means for determining the pressure inside said at least one combustion chamber.

According to one embodiment said means for adapting the combustion engine control and/or of the diagnostic system of the combustion engine are arranged to perform said adaption at at least one pre-determined crankshaft angle and/or at at least one crank shaft angle interval.

According to one embodiment said means for adapting the combustion engine control and/or of the diagnostic system of the combustion engine are arranged to perform an adaption of at least one out of the following quantities: heat capacity ratio of the gas in said at least one combustion chamber, the compression ratio at said combustion engine, or sensitivity of a sensor, such as a pressure sensor for measuring the pressure in said at least one combustion chamber and/or such as a knock/acceleration sensor used to determine the pressure in said at least one combustion chamber.

According to one embodiment said means for adapting the combustion engine control and/or of the diagnostic system of the combustion engine comprise means for adapting at least one quantity such as the heat capacity ratio of the gas in said at least one combustion chamber, the compression ratio at said combustion engine or the sensitivity of a sensor, such as a pressure sensor for measuring the pressure in said at least one combustion chamber and/or such as a knock/acceleration sensor used to determine the pressure in said at least one combustion chamber, for compensating by said at least one quantity for production tolerances of at least one component of the combustion engine, and/or for compensating by said at least one quantity for wear of at least one component of the combustion engine, and/or by compensating by said at least one quantity for the fuel quality of at least one fuel supplied to the combustion engine.

According to one embodiment said means for adapting the combustion engine control and/or of the diagnostic system of the combustion engine are arranged for adapting at least one maximum volume deviation in said at least one combustion chamber.

According to one embodiment the system is arranged to perform said adaption in real-time.

According to one embodiment said means for adapting the combustion engine control and/or the diagnostic system of the combustion engine comprise means for adapting at least one parameter in a particulate matter and/or NOx estimation method for the combustion engine.

At least one of the objectives is also achieved by a vehicle, comprising the system according to the present disclosure.

At least one of the objectives is also achieved by a computer program for improving heat release evaluation at a reciprocating internal combustion engine. Said computer program comprises program code for causing an electronic control unit or a computer connected to the electronic control unit to perform the steps according to the method of the present disclosure.

At least one of the objectives is also achieved by a computer program product containing a program code stored on a computer-readable medium for performing method steps according to the present disclosure, when said computer program is run on an electronic control unit or a computer connected to the electronic control unit.

The system, the vehicle, the computer program and the computer program product have corresponding advantages as have been described in connection with the corresponding examples of the method according to this disclosure.

Further advantages of the present invention are described in the following detailed description and/or will arise to a person skilled in the art when performing the invention.

### BRIEF DESCRIPTION OF THE DRAWINGS

For a more detailed understanding of the present invention and its objects and advantages, reference is made to the following detailed description which should be read together with the accompanying drawings. Same reference numbers refer to same components in the different figures. In the following,

FIG. 1 shows, in a schematic way, a vehicle according to one embodiment of the present invention;

FIG. 2 shows, in a schematic way, a system according to one embodiment of the present invention;

FIG. 3 shows, in a schematic way, a flow chart over an example of a method according to the present invention;

FIG. 4 shows a relation as can be observed in relation to the present disclosure; and

FIG. 5 shows, in a schematic way, a device which can be used in connection with the present invention.

### DETAILED DESCRIPTION OF THE INVENTION

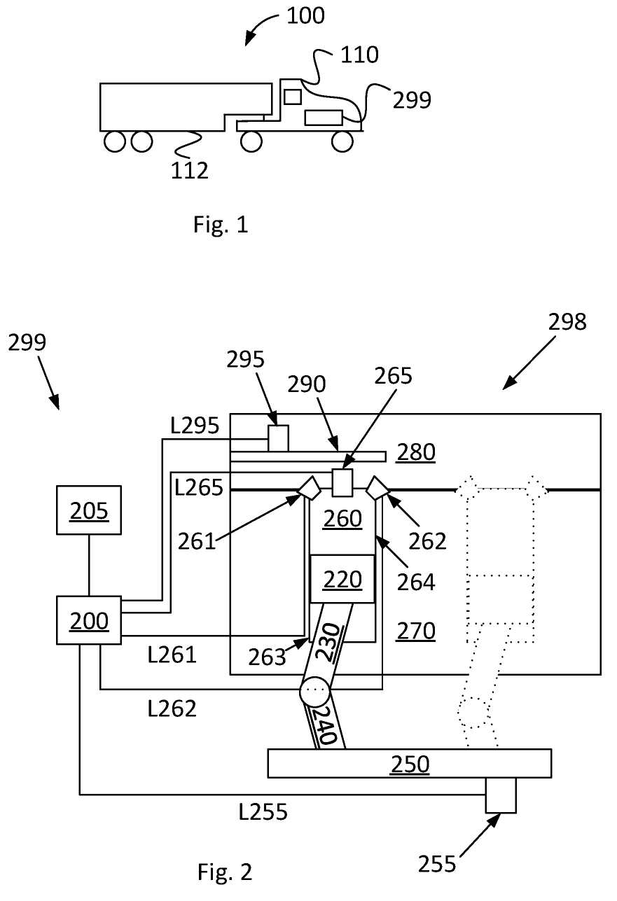

FIG. 1 shows a side view of a vehicle 100. In the shown example, the vehicle comprises a tractor unit 110 and a trailer unit 112. The vehicle 100 can be a heavy vehicle such as a truck. In one example, no trailer unit is connected to the vehicle 100. The vehicle 100 comprises a reciprocating internal combustion engine. The vehicle comprises a system 299 for improving heat release evaluation at the reciprocating internal combustion engine. This is described in more detail in relation to FIG. 2. The system 299 can be arranged in the tractor unit 110.

In one example, the vehicle 100 is a bus. The vehicle 100 can be any kind of vehicle comprising a reciprocating combustion engine. Other examples of vehicles comprising a reciprocating combustion engine are boats, passenger cars, construction vehicles, and locomotives.

The term “link” refers herein to a communication link which may be a physical connection such as an opto-electronic communication line, or a non-physical connection such as a wireless connection, e.g. a radio link or microwave link.

FIG. 2 depicts, in a schematic way, an embodiment of a system 299 for improving heat release evaluation at a reciprocating internal combustion engine 298. In the following, the terms reciprocating and internal will be omitted. It should, however, be understood that a combustion engine in the following description always refers to a reciprocating internal combustion engine.

Said combustion engine 298 comprises a cylinder block 270 and a cylinder head 280. Said combustion engine 298 further comprises at least one cylinder 263 with a combustion chamber 260. In the depicted figure only one cylinder is schematically explained in detail. It should, however, be understood that the combustion engine 298 generally comprises more than one cylinder, as is indicated by the dotted lines. The combustion engine 298 can comprise two, three, four, five, six, eight, ten, twelve, sixteen, or any other number of cylinders. It should also be noted that everything explained in relation to cylinder 263 can also apply to any of the other cylinders.

Inside the cylinder 263, a piston 220 is arranged which in a first approximation can move back and forth in one direction. The piston 220 is connected to a conrod 230. Said conrod 230 is connected to a crankpin 240 of a crankshaft 250. Said crankshaft 250 is arranged to rotate. Said crankshaft 250 is arranged to coordinate the movement of the pistons in the cylinders due to the connection of these pistons, via the respective conrods and the respective crankpins to the crankshaft 250.

Assuming completely constant temperature in the combustion engine and assuming that mass and pressure forces would not change the geometrical shape of components of the combustion engine, the volume of the combustion chamber 260 would solely be influenced by the orientation of the crankshaft 250 which determines the position of the piston 220. That volume of the combustion chamber 260 is in the following denoted as the ideal volume. The ideal volume is thus solely dependent on the orientation of the crankshaft 250. However, in reality the temperature in the combustion engine 298 is not constant. A change of temperature can thus affect the shape of components of the combustion engine 298. Further, in reality mass and pressure forces do influence the geometrical shape of components of the combustion engine 298. As a result, the volume of the combustion chamber 260 will generally depend on more parameters than the orientation of the crankshaft 250. The difference between the real volume of the combustion chamber 260 and the ideal volume of the combustion chamber 260 is here, and in the rest of this disclosure, denoted as volume deviation.

Said combustion engine 298 comprises at least one inlet valve 261 to the cylinder 263. Said combustion engine comprises at least one exhaust valve 262 to the cylinder 263. Said cylinder 263 comprises a cylinder liner 264. In the rest of the disclosure only one inlet valve and only one exhaust valve are described. It should, however, be understood that if the cylinder 263 has more than one such valves, the method and/or the system can be easily adapted to refer to any number of inlet and/or exhaust valves of a cylinder. Especially the opened or closed state can relate to the opened or close state of any number of inlet or exhaust valves.

Said combustion engine 298 comprises a media transport arrangement 290. Said media transport arrangement can comprise pipes, tubes, or the like. Said media can be fuel, lubricants, oil, or any other media. The media transport arrangement 290 can comprise different media transport arrangements for different media (not shown in the figure). The media transport arrangement 290 can be arranged to supply said media to specific components of the combustion engine 298, such as to the combustion chamber 260 (not shown in the figure).

Said system 299 comprises means for determining a first set of dynamic parameters relating to the combustion engine. Said means for determining the first set of dynamic parameters relating to the combustion engine can comprise means 255 for determining a crank angle degree. Said means 255 can comprise a crank angle degree sensor. Said sensor can be an optical and/or an electrical and/or a tactile sensor. It is well known in the art how to determine the crank angle degree. Therefore, this is not described here any further.

Said means for determining the first set of dynamic parameters relating to the combustion engine can comprise means for determining a rotary speed of the crankshaft 250. Said means 255 can comprise means for determining a rotary speed of the crankshaft 250. In one example said means for determining a rotary speed of the crankshaft 250 are arranged to count how often the crankshaft rotates per time unit. From this a rotary speed can be determined.

Said means for determining the first set of dynamic parameters relating to the combustion engine can comprise means for determining the temperature of the crankshaft 250. Said means for determining the temperature of the crankshaft 250 can be a temperature sensor at the crankshaft 250 (not shown).

Said means for determining the first set of dynamic parameters relating to the combustion engine can comprise means for determining the temperature of the conrod 230. Said means for determining the temperature of the conrod 230 can be a temperature sensor at the conrod 230 (not shown).

Said means for determining the first set of dynamic parameters relating to the combustion engine can comprise means for determining the temperature of the piston 220. Said means for determining the temperature of the piston 220 can be a temperature sensor at the piston 220 (not shown).

Said means for determining the first set of dynamic parameters relating to the combustion engine can comprise means for determining the temperature of the cylinder block 270. Said means for determining the temperature of the cylinder block 270 can be a temperature sensor at the cylinder block 270 (not shown).

Said means for determining the first set of dynamic parameters relating to the combustion engine can comprise means for determining the temperature of the cylinder head 280. Said means for determining the temperature of the cylinder head 280 can be a temperature sensor at the cylinder head 280 (not shown).

Said means for determining the first set of dynamic parameters relating to the combustion engine can comprise means for determining the temperature of at least one medium in the combustion engine 298. Said means for determining the temperature of at least one medium in the combustion engine 298 can be a temperature sensor arrangement at the media transport arrangement 290 (not shown). In one example the temperature sensor arrangement at the media transport arrangement 290 comprises a lubricant and/or oil temperature sensor. In one example the temperature sensor arrangement at the media transport arrangement 290 comprises a fuel temperature sensor.

Said means for determining the first set of dynamic parameters relating to the combustion engine can comprise means 295 for determining a mass flow of at least one medium in the combustion engine 298. Said means 295 for determining a mass flow of at least one medium in the combustion engine 298 can be a mass flow sensor arrangement at the media transport arrangement 290 (not shown). In one example the mass flow sensor arrangement at the media transport arrangement 290 comprises a mass flow sensor arranged for determining the mass flow of a lubricant and/or oil. In one example the mass flow sensor arrangement at the media transport arrangement 290 comprises a mass flow sensor arranged for determining the mass flow of a fuel.

Said means for determining the first set of dynamic parameters relating to the combustion engine can comprise means 265 for determining the pressure inside the combustion chamber 260. Said means 265 can comprise a pressure sensor at the combustion chamber 260.

Said system 299 comprises a first control unit 200. Any of said temperature sensor(s) can be arranged to transmit a measured temperature to the first control unit 200. Said first control unit 200 can be arranged to control operation of any of said temperature sensor(s). Said first control unit 200 is arranged for communication with any of said temperature sensor(s) via a link (not shown). Said first control unit 200 is arranged to receive information from any of said temperature sensor(s).

Said means 255 for determining a crank angle degree can be arranged to transmit data to the first control unit 200. Said first control unit 200 can be arranged to control operation of said means 255 for determining a crank angle degree. Said first control unit 200 is arranged for communication with said means 255 for determining a crank angle degree via a link L255. Said first control unit 200 is arranged to receive information from means 255 for determining a crank angle degree. Said first control unit 200 can be arranged to determine a crank angle degree based on the data from said means 255 for determining a crank angle degree.

Said means for determining a rotary speed of the crankshaft 250 can be arranged to transmit data to the first control unit 200. Said first control unit 200 can be arranged to control operation of said means for determining a rotary speed of the crankshaft 250. Said first control unit 200 is arranged for communication with said means for determining a rotary speed of the crankshaft 250 via a link (not shown). Said first control unit 200 is arranged to receive information from said means for determining a rotary speed of the crankshaft 250. Said first control unit 200 can be arranged to determine a rotary speed of the crankshaft 250 based on the data from said means for determining a rotary speed of the crankshaft 250.

Said means 295 for determining a mass flow of at least one medium in the combustion engine 298 can be arranged to transmit data to the first control unit 200. Said first control unit 200 can be arranged to control operation of said means 295 for determining a mass flow of at least one medium in the combustion engine 298. Said first control unit 200 is arranged for communication with said means 295 for determining a mass flow of at least one medium in the combustion engine 298 via a link L295. Said first control unit 200 is arranged to receive information from means 295 for determining a mass flow of at least one medium in the combustion engine 298. Said first control unit 200 can be arranged to determine a mass flow of at least one medium in the combustion engine 298 based on the data from said means 295 for determining a mass flow of at least one medium in the combustion engine 298.

Said means 265 for determining the pressure inside the combustion chamber 260 can be arranged to transmit data to the first control unit 200. Said first control unit 200 can be arranged to control operation of said means 265 for determining the pressure inside the combustion chamber 260. Said first control unit 200 is arranged for communication with said means 265 for determining the pressure inside the combustion chamber 260 via a link L265. Said first control unit 200 is arranged to receive information from said means 265 for determining the pressure inside the combustion chamber 260. Said first control unit 200 can be arranged to determine the pressure inside the combustion chamber 260 based on the data from said means 265 for determining the pressure inside the combustion chamber 260.

Said first control unit 200 can be arranged to determine the temperature of a component 220, 230, 240, 250, 264, 270, 280 of the combustion engine or of a medium based on a physical model of at least parts of the combustion engine and/or based on a measured temperature of a component 220, 230, 240, 250, 264, 270, 280 of the combustion engine and/or based on a measured temperature and/or a measured mass flow of a medium. As an example, the temperature of the crankshaft 250 can be determined based on a physical model and based on the temperature of the oil surrounding it. The physical model can be that the temperature of the crankshaft 250 and the surrounding oil are equal. This dispenses with the need of a temperature sensor for the crankshaft.

Especially for components fully or partly inside the cylinder it is often difficult to directly measure the temperature. Thus, the temperature of the piston 220, the conrod 230, the cylinder liner 264, and/or other components can be determined based on a physical model and the measured temperature from other temperature sensors described above and/or mass flow sensors described above. Said physical model can comprise thermodynamic relations, such as relations regarding heat transport in the components of the combustion engine 298.

Said first control unit 200 can be arranged to control operation of said inlet valve 261. Said first control unit 200 is arranged for communication with said inlet valve 261 via a link L261. Said first control unit 200 can be arranged to receive information from said inlet valve 261.

Said first control unit 200 can be arranged to control operation of said exhaust valve 262. Said first control unit 200 is arranged for communication with said exhaust valve 262 via a link L262. Said first control unit 200 can be arranged to receive information from said exhaust valve 262.

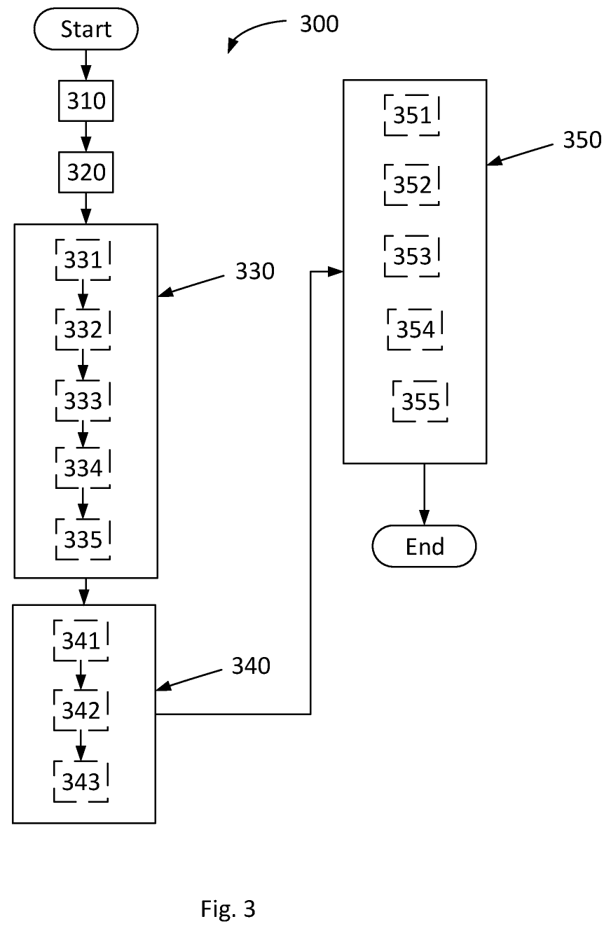

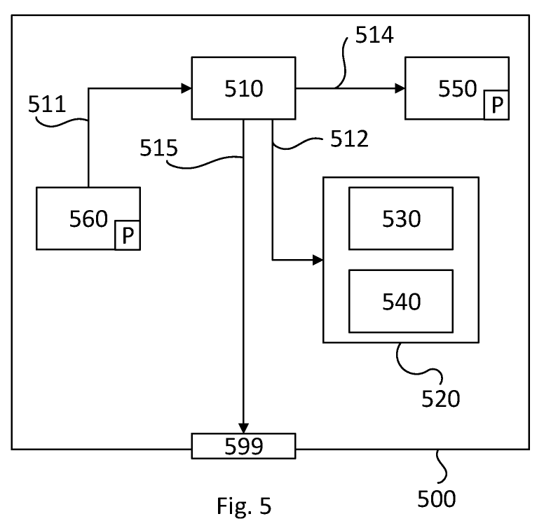

Said first control unit 200 can be arranged for providing a model regarding volume deviations in the combustion chamber based on the first set of dynamic parameters of the combustion engine, wherein said model comprises volume deviations due to thermal changes, due to mass forces and due to pressure forces. Said model is further described in relation to FIG. 3. Said model can be stored in a memory of said first control unit 200. This is further described in relation to FIG. 5.

Said control unit is arranged for determining the volume deviation in the combustion chamber based on said provided model regarding volume deviations in the combustion chamber and based on said first set of determined dynamic parameters. This is further described in relation to FIG. 3.

Said first control unit 200 can be arranged for providing an adaption model for the combustion engine, wherein said adaption model is based on said determined volume deviation in the combustion chamber. This is further described in relation to FIG. 3.

Said first control unit 200 can be arranged for adapting a combustion engine control and/or a diagnostic system of the combustion engine based on said adaption model so that said heat release evaluation is improved. Said combustion engine control and/or a diagnostic system can be part of said first control unit 200. Said first control unit 200 can be arranged for adapting at least one parameter related to heat release evaluation. This is described in more detail in relation to FIG. 3.

The first control unit 200 can be arranged to perform said adaption at at least one pre-determined crankshaft angle and/or at at least one crankshaft angle interval.

Said first control unit 200 can be arranged to adapt at least one quality. Said at least one quantity can comprise a value for a heat capacity ratio of the gas in the cylinder. Said at least one quality can comprise a value for a compression ratio at said combustion engine. Said at least one quantity can comprise the sensitivity of a sensor, such as the pressure sensor for measuring the pressure in the combustion chamber and/or such as a knock/acceleration sensor used to determine the pressure in the combustion chamber.

Said first control unit 200 can be arranged to perform said adaption for compensating by said at least one quantity for production tolerances of at least one component 220, 230, 240, 250, 264, 270, 280 of the combustion engine 298, and/or for compensating by said at least one quantity for wear of said at least one component 220, 230, 240, 250, 264, 270, 280 of the combustion engine 298, and/or by compensating by said at least one quantity for the fuel quality of at least one fuel supplied to the combustion engine 298.

Said first control unit 200 can be arranged for adapting at least one maximum volume deviation in the combustion chamber 298.

Said first control unit 200 can be arranged for adapting at least one parameter in a particulate matter and/or NOx estimation method for the combustion engine. Further details regarding the adaption are described in relation to FIG. 3-5.

A second control unit 205 is arranged for communication with the first control unit 200 via a link L205 and may be detachably connected to it. It may be a control unit external to the vehicle 100. It may be adapted to conducting the innovative method steps according to the invention. The second control unit 205 may be arranged to perform the inventive method steps according to the invention. It may be used to cross-load software to the first control unit 200, particularly software for conducting the innovative method. It may alternatively be arranged for communication with the first control unit 200 via an internal network on board the vehicle. It may be adapted to performing substantially the same functions as the first control unit 200, such as improving heat release evaluation at the reciprocating combustion engine. The innovative method may be conducted by the first control unit 200 or the second control unit 205, or by both of them.

The system 299 can perform any of the method steps described later in relation to FIG. 3.

FIG. 3 shows, in a schematic way, a flow chart over an example of a method 300 for improving heat release evaluation at a reciprocating combustion engine according to the present invention. It should be understood that method 300 can be performed for any number of cylinders in the combustion engine. Thus, in one example method 300 is only performed for one of the cylinders in the combustion engine. In one example, method 300 is performed for all cylinders of the combustion engine. The method 300 starts with step 310.

In step 310 a model regarding volume deviations in the combustion chamber is provided. Said volume deviations in the combustion chamber in said model are based on a first set of dynamic parameters of the combustion engine. Said model comprises volume deviations due to thermal changes, due to mass forces and due to pressure forces. Here, and in the whole description the term dynamic parameters relates to parameters which are not constant over time. In one example, said model regarding volume deviations comprises thermal expansion of one or more components of the combustion engine. In one example, said model comprises mass forces acting of one or more components of the combustion engine. In one example, said model comprises pressure forces acting on one or more components of the combustion engine. Said first set of dynamic parameters comprises in one example a crank angle degree, CAD. Said first set of dynamic parameters comprises in one example a rotary speed of the crankshaft. Said first set of dynamic parameters comprises in one example a temperature of the crankshaft. Said first set of dynamic parameters comprises in one example a temperature of the conrod. Said first set of dynamic parameters comprises in one example a temperature of the piston. Said first set of dynamic parameters comprises in one example a temperature of the cylinder block. Said first set of dynamic parameters comprises in one example a temperature of the cylinder head. Said first set of dynamic parameters comprises in one example a pressure inside the combustion chamber.

More details of the model are described in relation to step 330. The method continues with step 320.

In step 320 the first set of dynamic parameters relating to the combustion engine is determined. In one example at least one of said dynamic parameters is measured. In one example, at least one of said dynamic parameters is calculated. In one example, said crank angle degree is determined with a crank angle sensor. In one example, said rotary speed of the crankshaft is determined with a crank angle sensor. In one example, a temperature of a component of the combustion engine is determined by a temperature sensor at said component. In one example, a temperature of a component of the combustion engine is determined by at least one temperature sensor in the combustion engine and/or at least one mass flow sensor regarding fuel to the combustion chamber and/or exhaust gas from the combustion chamber and based on a physical model of how measurement(s) of said at least one sensors relate to the temperature of said component of the combustion engine. In one example, said pressure inside the combustion chamber is measured by a pressure sensor in the combustion chamber. Said method continues with step 330.

In step 330 the volume deviation in the combustion chamber is determined based on said provided model and based on said first set of determined dynamic parameters. In one example step 330 comprises at least one of the steps 331-335. In one example, step 330 comprises all of the steps 331-335. In case any of the steps 331-335 are comprised in step 330, these steps are preferably performed in the order depicted in FIG. 3.

In step 331 temperature influenced geometrical changes of a first set of components of the combustion engine are determined. Said first set of components can comprise at least one of the following components: the crankshaft, the conrod, the piston, the cylinder block, the cylinder head. At least one first temperature is determined. This is preferably performed first. Said at least one first temperature can be measured and/or calculated. Said at least one first temperature can relate to at least one temperature of a second set of components or/and media in the combustion engine. Said second set can comprise any of the components of the first set. Said second set can comprise any of the media in the combustion engine, such as lubricants, oil, cooling fluids, or the like. After having determined said at least one first temperature, the temperatures of said first set of components are determined. In case any of the components in the second set are comprised in the first set, the temperature has already been determined for that component and can thus be used. In case any of the components in the first set is not comprised in the second set, the temperature of this component can be determined via physical relations, such as thermodynamic laws, from the temperature of the components and/or media in the second set.

The positive or negative expansion due to temperature is determined for said first set of components. Said positive or negative expansion corresponds in one example to said temperature influenced geometrical changes. Preferably, said expansion is determined as linearly depending on temperature changes. Preferably, step 332 is performed after step 331.

In step 332 mass forces and/or pressure forces are determined. In one example, step 332 comprises determining the position of a third set of components of the combustion engine. Said third set of components can comprise any of the components described in relation to the first set of components. Step 332 can comprise determining the forces on said third set of components. In one example, said positions and/or said forces are determined in two dimensions. In one example, said two dimensions relate to the moving direction of the piston and to the moving direction of the conrod perpendicular to the moving direction of the piston. Said two directions will in the following be referred to as z-direction and y-direction, respectively. This has the advantage that two-dimensional calculations can be performed faster than three-dimensional calculations. In a preferred embodiment, thus no forces or positions are determined in the longitudinal direction of the crankshaft. In the most common designs of combustion engines it is a fairly justified assumption that the components are not moving in that direction and are not experienced to forces in the same order as forces in the other two directions.

In one example, step 332 comprises determining at least one change in the geometrical shape of a fourth set of components of the combustion engine due to said determined forces. Said fourth set of components can comprise any of the components described in relation to the first set of components. In a preferred example said fourth set of components comprises at least the conrod. In one example, said at least one change comprises the length of the components in said first set. In one example, it is assumed that changes in the length of a component of the combustion engine are linearly proportional to the force component in the direction of the length of that component of the combustion engine. In one example it is assumed that a bending deformation of a component of the combustion engine is linearly proportional to the force component in the direction of bending. Preferably, the bending of the crankshaft is determined based on the forces in all cylinders of the combustion engine.

In one example step 332 comprises determining the position of a fifth set of components in bearings of the combustion engine. Said fifth set of components can comprise any of the components described in relation to the first set of components. In one example, said determining of the position is modelled as a two-dimensional hysteresis where the force balance determines the position at the attachment of the bearings. This avoids using ordinary differential equations, which might be time consuming.

In one example, step 332 comprises determining a displacement in the y-direction of the attachment of the piston to the conrod.

In one example, step 332 comprises determining the position of the piston in the z-direction. Said determining of the position of the piston in the z-direction can be based on any of the above described actions in relation to step 332. Preferably step 333 is performed after step 332.

In step 333 the deformation of the cylinder head is determined. In one example, step 333 comprises determining at least one second temperature. Said at least one second temperature can be measured and/or calculated. Said at least one second temperature can relate to at least one temperature of a sixth set of components or/and media in the combustion engine. Said sixth set can comprise any of the components described in relation to the first set. Said sixth set can comprise any of the media in the combustion engine, such as lubricants, oil, cooling fluids, or the like. In case any of said at least one second temperature corresponds to any of said at least one first temperature in step 331, it is preferred to use these corresponding temperature(s). This avoids measuring the same temperature twice.

After having determined said at least one second temperature, the temperatures of the cylinder head is determined. The temperature of the cylinder head can be determined via physical relations, such as thermodynamic laws, from the temperature of the components and/or media in the sixth set.

In one example, the deformation of the cylinder head is determined based on the assumption that a geometrical change of the cylinder head is linearly proportional to a deviation of the temperature of the cylinder head compared to a first reference temperature.

In one example, the deformation of the cylinder head is determined based on the assumption that a geometrical change of the cylinder head is linearly proportional to a pressure change of the pressure inside the combustion chamber.

Said geometrical change can relate to a change in length and/or a change in volume of the cylinder head. Preferably step 334 is performed after step 333.

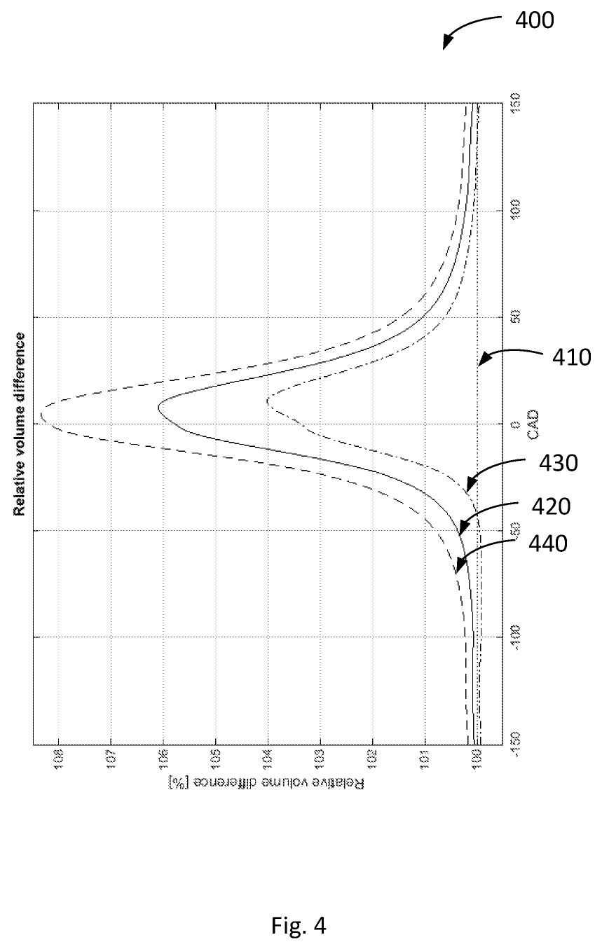

In step 334 the total volume deviation of the combustion chamber is determined. In a preferred example, said total volume deviation is a sum of the deviations which have been determined in step 331, 332, and 333. In case any of the steps 331-333 has not been performed, the total volume deviation can be determined as the sum of the deviation determined from those of steps 331-333 which have been performed. In one example, said total volume deviation is determined as a function of the crank angle degree. This is depicted in FIG. 4. Preferably step 335 is performed after step 334.

In step 335, step 334 is repeated with the maximum allowable deviations due to production tolerance of the geometrical shapes of the components of the combustion engine. In one example, step 334 is repeated so as to determine the maximum possible total volume deviation due to production tolerances. In one example, step 334 is repeated so as to determine the minimum possible total volume deviation due to production tolerances. This is depicted in FIG. 4. Performing step 335 has the advantage of determining the robustness of the determination of step 334. The determined values from step 335 are especially useful as input data to diagnosis method for the combustion engine and/or to a method for protecting the combustion engine, for example so as to limit control parameters of the combustion engine.

Step 330 preferably finishes after step 334 or 335. After step 330, step 340 is performed.

In step 340 an adaption model is provided for the combustion engine, wherein said adaption model is based on said determined volume deviation in the combustion chamber. Step 340 can comprise any of steps 341-343.

In step 341 a first range of crank angle degrees is defined. In one example, said first range of crank angle degrees relates to a range of crank angle degrees where the determined volume deviation of the combustion chamber is significant. In one example the term significant relates to a relative deviation of 0.2% of the ideal volume of the combustion chamber. In one example the term significant relates to a relative deviation of 1% of the ideal volume of the combustion chamber. In one example the term significant relates to a relative deviation of 2% of the ideal volume of the combustion chamber.

In one example the term significant relates to the range]−50 CAD,50 CAD[, or]−80 CAD,80 CAD[, or]−30 CAD,40 CAD[. The term CAD refers to crank angle degree. It is assumed that a crank angle degree of zero is achieved where the corresponding piston has its top dead centre, TDC. These ranges are especially useful for cold engines.

In one example the term significant relates to the range]−30 CAD,50 CAD[, or]−80 CAD,80 CAD[, or]−50 CAD,40 CAD[. These ranges are especially useful for warm engines. Preferably step 342 is performed after step 341.

In step 342 a relation how the volume deviation relates to at least a second set of dynamic parameters is provided. Said relation can be a simplified relation. Said second set of dynamic parameters can comprise at least one out of the following quantities: a pressure inside the combustion chamber, a temperature of a medium and/or an element, such as temperature of a lubricant and/or oil, temperature of a cylinder liner of the combustion engine, temperature of the crankshaft, temperature of the conrod, temperature of the piston, crank angle degree, rotary speed of the crankshaft, gas composition in the cylinder, whether an inlet valve to a cylinder of the combustion engine is open or closed, whether an exhaust valve to a cylinder of the combustion engine is open or closed.

In one example a simplified relation for the volume deviation in a second range of crank angle degrees is determined. In one example said second range corresponds to said first range of crank angle degrees.

In one example, said simplified relation comprises that the volume deviation increases linearly until a maximum value of the volume deviation and decreases linearly after said maximum value of the volume deviation.

In one example, said simplified relation comprises that the volume deviation increases linearly until a first value of the volume deviation, than linearly until a maximum value of the volume deviation and decreases linearly after said maximum value of the volume deviation.

In one example, said simplified relation comprises that the volume deviation starts at a local minimum of the volume deviation and stops at a local maximum of the volume deviation.

In one example, said simplified relation comprises that the volume deviation is proportional to the difference between the pressure inside the combustion chamber and a pre-determined reference pressure.

In one example, said simplified relation comprises that the volume deviation is proportional to a temperature of a component or a media of the combustion engine, such as the temperature of a lubricant and/or oil, of the cylinder block, or of the conrod.

In one example, said simplified relation comprises that the volume deviation is proportional to the load of the engine.

In one example, said simplified relation comprises that the volume deviation is proportional to the rotational speed of the crankshaft squared. In one example, said simplified relation comprises that the volume deviation is proportional to the rotational speed of the crankshaft.

Said simplified relation can be a combination of some or all of the above named relations. It will be understood that a chosen relation has to be adapted to a specific version of a combustion engine, as different combustion engines in general will require a different simplified relation. Specifically the coefficients in the above named relation will in general differ between different versions of combustion engines. After step 342, preferably step 343 is performed.

In step 343 at least one crank angle degree, or at least one interval of crank angle degrees is determined for the adaption. Said determination is preferably performed in relation to the simplified relation for the volume deviation. This will significantly reduce computation time. It should, however, be noted that said determination in principle also can be performed in relation to the determined volume deviation in step 330.

In an example a), said at least one crank angle degree is the crank angle degree where the maximum volume deviation is expected. Here, and in the following example, the term expected relates to an expectation based on the determined volume deviation in step 330 and/or an expectation in relation to said simplified relation.

In an example b), said at least one crank angle corresponds to an expected maximum volume deviation which occurs before a significant combustion process has started.

In an example c), said at least one interval of crank angle degrees comprises one interval outside said first defined range of crank angle degrees and one interval inside said first defined range of crank angle degrees.

In an example d), said at least one interval of crank angle degrees is an interval outside said first defined range of crank angle degrees.

In an example e), said at least one crank angle degree is a crank angle degree where a different volume deviation is expected for a warm combustion engine compared to a cold combustion engine.

In one example, said at least one crank angle degree or said at least one interval of crank angle degrees is a combination of any of examples a)-e).

In one example, any of the steps 341-343 or some or all of these steps in combination provide said adaption model. It will be understood that a specific combination will depend both on a parameter or the like which should be adapted, and/or on a specific version of a combustion engine. Some examples of which combinations of these steps are especially useful for what quantity are discussed in relation to step 350. The method continues with step 350.

In step 350 the combustion engine control and/or a diagnostic system of the combustion engine is adapted based on said adaption model. Said adaption is performed so that said heat release evaluation is improved. In one example, said improving of the heat release evaluation relates to adapting at least one parameter related to said heat release evaluation.

Step 350 can comprise any of steps 351-355. In step 351 a value for the heat capacity ratio of the gas in the cylinder is adapted. Said adaption is preferably performed at said at least one interval of crank angle degrees as described in relation to example d) of step 343.

In step 352 the sensitivity of at least one sensor is adapted. In one example said sensor is a pressure sensor for measuring the pressure in the combustion chamber. In one example said sensor is a knock/acceleration sensor used to determine the pressure in the combustion chamber. Said sensitivity can relate to the sensitivity of a value in an output of said at least one sensor in relation to the pressure inside the combustion chamber. In one example the signal strength of said at least one sensor is adapted. Said adaption is preferably performed at said at least one interval of crank angle degrees as described in relation to example d) of step 343.

Step 353 can comprise adapting at least one quantity for compensating by said at least one quantity for production tolerances of at least one component of the combustion engine. Step 353 can comprise adapting said at least one quantity for compensating by said at least one quantity for wear of at least one component of the combustion engine. Step 353 can comprise adapting at least one quantity for compensating by said at least one quantity for the fuel quality of at least one fuel supplied to the combustion engine. This has the advantage that the exact actual geometrical shape of said at least one component of the combustion engine does not need to be known when the method 300 is performed. Instead, it is sufficient to know the ideal geometrical shape, and preferably the allowable production tolerances. Said adaption is then performed to adapt the combustion engine control and/or a diagnostic system of the combustion engine to the actual geometrical shape of said at least one component. Since the geometrical shape of individual combustion engines may differ from each other, even though they belong to the same version of a combustion engine, for example due to production tolerances and/or due to wear, the method dispenses with the need to perform exact measurements of the geometrical shape of the components of the combustion engine. To perform such measurements on each individual component of each individual combustion engine would require a lot of effort and would require a lot of working time, thus increasing the costs for a combustion engine. The present method thus achieves the advantage of compensating for changes of the geometrical shape for individual components of individual combustion engines without the need to measure these changes.

Said at least one quantity comprises in one example the heat capacity ratio of the gas in the cylinder. Said at least one quantity comprises in one example the compression ratio at the combustion engine. Said at least one quantity comprises in one example the sensitivity of a sensor, such as a pressure sensor for measuring the pressure in the combustion chamber and/or such as a knock/acceleration sensor used to determine the pressure in the combustion chamber. Said adaption is in one example performed at said at least one crank angle degree or said at least one interval of crank angle degrees as described in relation to example a)-c) of step 343. Said adaption is in one example performed at said at least one crank angle degree or said at least one interval of crank angle degrees as described in relation to example a)-c) and e) of step 343.

In one example, the value of the heat capacity ratio of the gas in the cylinder is adapted for compensation for production tolerances and/or wear. The value of the heat capacity ratio can then be allowed to vary according to example a)-c), or according to example a)-c) and e) of step 343. In such a way the volume deviation is compensated for by varying the value of the heat capacity ratio.

In one example, the sensitivity of a sensor is adapted for compensation for production tolerances and/or wear. The sensitivity can then be allowed to vary according to example a)-c), or according to example a)-c) and e) of step 343. In such a way the volume deviation is compensated for by varying the sensitivity of the sensor.

Step 353 can comprise adapting at least one maximum volume deviation in the combustion chamber. Said adaption is in one example performed at said at least one crank angle degree or said at least one interval of crank angle degrees as described in relation to example a)-c) of step 343. Said adaption is in one example performed at said at least one crank angle degree or said at least one interval of crank angle degrees as described in relation to example a)-c) and e) of step 343. In one example, said at least one maximum volume deviation in the combustion chamber is adapted as a function of the pressure in the combustion chamber. In such a way a compensation for wear and/or production tolerances and/or fuel quality as described in relation to step 353 can be achieved.

In step 354 a value for the compression ratio at the combustion engine is adapted.

In step 355 at least one parameter in a particulate matter and/or NOx estimation method for the combustion engine is adapted. This can be performed in a corresponding way to what has been described before in relation to the adaption of other quantities or values.

After step 350 the method 300 ends.

It should be noted that the specific implementation of the method 300 will depend on what quantities are relevant for a specific combustion engine and what sensors are available at that specific combustion engine. The above description provides several examples of how the adaption can be performed and a person skilled in the art will thus have the freedom to combine these examples in the best suitable way for a specific implementation. Especially it should be noted that the method 300 can be performed on the system 299 described in relation to FIG. 2. More specifically, any of the steps 300 can be performed on one or more of the components of the system 299.

The steps of method 300 can be performed in other orders or in parallel as well. The only limitation is where one step needs the outcome of a previous step as its input. One or more of the steps of method 300 can be repeated. Said repeating can be performed continuously. Said repeating can be performed at pre-determined time-intervals. Said pre-determined time-intervals can be different for different steps. In one example, said steps comprising determining of parameters and volume deviation are performed more often than the steps comprising providing a model. In one example, said steps comprising adapting are performed more often than the steps comprising providing a model. This is especially useful for assuring that the method can be performed in real-time at a combustion engine. The term real-time herein relates to the fact that an adaption of the combustion engine control and/or the diagnostic system can be performed faster than the changes the adaption adjusts for. In one example, the adaption is thus faster than the engine is worn. In one example, the adaption is faster than parts are changed and/or the engine is refueled. The speed of adaption can thus depend on the aim of the adaptive adjustment of the combustion engine control and/or diagnostic system.

FIG. 4 depicts a relation 400 between a relative volume deviation as a function of the crank angle degree, CAD. Said relation can be the outcome of a model regarding volume deviations in the combustion chamber as described in relation to the present disclosure. The dotted line 410 depicts the ideal volume as described above. It should be noted that said ideal volume is not a constant volume but changed with the CAD as the piston moves back and forth. However, since the volume deviation relates to the ideal volume, the ideal volume will always correspond to 100%. In other words, the ideal volume does not deviate from the ideal volume.

The continuous line 420 depicts the volume deviation according to the geometrical specifications of a specific version of a combustion engine. As can be seen the deviation has the highest value around TDC(s), i.e. around CAD=0. In this example, the volume deviation is above 5%. However, in general it will not be known if an individual combustion engine is produced exactly according to the perfect specification or whether there are any production tolerances at the components of the combustion engine. Said production tolerances can relate to allowable production tolerances.

The dash-dotted line 430 depicts the volume deviation according to a first extremum of the production tolerances. This first extremum relates to the fact that all production tolerances add in such a way that a minimum volume deviation is achieved. As can be seen, the minimum volume deviation will still result in a volume deviation of more than 3% close to the TDC.

The dashed line 440 depicts the volume deviation according to a second extremum of the production tolerances. This second extremum relates to the fact that all production tolerances add in such a way that a maximum volume deviation is achieved. As can be seen, the maximum volume deviation will result in a volume deviation of nearly 8% close to the TDC.

It should be noted that the depicted Figure relates to a specific version of a combustion engine. Other versions of combustion engine can achieve higher or lower values of volume deviations. Experimental results have shown that combustion engines for trucks in general have higher volume deviations than combustion engines for cars.

Said lines 430 and 440 delimit the actual possible volume deviation of an individual member of a specific version of a combustion engine under the assumption that all parts of the combustion engine are inside its pre-determined production tolerances. Thus, the relation in FIG. 4 can be used for providing an adaption model for the combustion engine and/or for adapting the combustion engine control and/or a diagnostic system of the combustion engine based on said adaption model. It should be noted that said adaption, as described in relation to FIG. 3, can result in that an individual member of the combustion engine is adapted for its individual production tolerances without knowing the exact individual production tolerances.

It should also be noted that FIG. 4 shows the situation for a specific load and for a specific relation of the combustion engine. The term specific relation can relate to the fact whether the combustion engine has just started, often called a cold combustion engine, or whether the combustion engine has reached its ordinary working temperature or working temperature range, often called a warm combustion engine. A similar figure to what is shown in FIG. 4 would in general look different for a different load of the engine, and/or for a different specific relation.

It should be noted that the present invention advantageously can be used when testing/evaluating an internal combustion engine, and/or the control of said internal combustion engine, e.g. in a so called test bench and/or a test cell.

FIG. 5 is a diagram of one version of a device 500. The control units 200 and 205 described with reference to FIG. 2 may in one version comprise the device 500. The device 500 comprises a non-volatile memory 520, a data processing unit 510 and a read/write memory 550. The non-volatile memory 520 has a first memory element 530 in which a computer program, e.g. an operating system, is stored for controlling the function of the device 500. The device 500 further comprises a bus controller, a serial communication port, I/O means, an A/D converter, a time and date input and transfer unit, an event counter and an interruption controller (not depicted). The non-volatile memory 520 has also a second memory element 540.

The computer program P comprises routines for improving heat release evaluation at a reciprocating combustion engine.

The computer program P may comprise routines for providing a model regarding volume deviations in the combustion chamber based on a first set of dynamic parameters of the combustion engine, wherein said model comprises volume deviations due to thermal changes, due to mass forces and due to pressure forces. This may at least partly be performed by means of said first control unit 200.

The computer program P may comprise routines for determining the first set of dynamic parameters relating to the combustion engine. This may at least partly be performed by means of said first control unit 200 and said means 265, 295, 255, and/or any of said temperature sensors. The computer program P may comprise routines for determining the crank angle degree, the rotary speed of the crankshaft, the temperature of the crankshaft, the temperature of the conrod, the temperature of the piston, the temperature of the cylinder block, the temperature of the cylinder head, and/or the pressure inside the combustion chamber. Said determined dynamic parameters can be stored in said non-volatile memory 520.

The computer program P may comprise routines for determining the volume deviation in the combustion chamber based on said provided model and based on said first set of determined dynamic parameters. This may at least partly be performed by means of said first control unit 200.

The computer program P may comprise routines for providing an adaption model for the combustion engine, wherein said adaption model is based on said determined volume deviation in the combustion chamber. This may at least partly be performed by means of said first control unit 200.

The computer program P may comprise routines for adapting the combustion engine control and/or a diagnostic system of the combustion engine based on said adaption model so that said heat release evaluation is improved. This may at least partly be performed by means of said first control unit 200.

The computer program P may comprise routines for adapting the heat capacity ratio of the gas in the cylinder, the compression ratio at the combustion engine, the sensitivity of a sensor, such as a pressure sensor for measuring the pressure in the combustion chamber and/or such as a knock/acceleration sensor used to determine the pressure in the combustion chamber. The computer program may comprise routines for adapting at least one parameter in a particulate matter and/or NOx estimation method for the combustion engine. This may at least partly be performed by means of said first control unit 200.

The program P may be stored in an executable form or in compressed form in a memory 560 and/or in a read/write memory 550.

Where it is stated that the data processing unit 510 performs a certain function, it means that it conducts a certain part of the program which is stored in the memory 560 or a certain part of the program which is stored in the read/write memory 550.

The data processing device 510 can communicate with a data port 599 via a data bus 515. The non-volatile memory 520 is intended for communication with the data processing unit 510 via a data bus 512. The separate memory 560 is intended to communicate with the data processing unit via a data bus 511. The read/write memory 550 is arranged to communicate with the data processing unit 510 via a data bus 514. The links L205, L220, L240, L250, and L270, for example, may be connected to the data port 599 (see FIG. 2).

When data are received on the data port 599, they can be stored temporarily in the second memory element 540. When input data received have been temporarily stored, the data processing unit 510 can be prepared to conduct code execution as described above.

Parts of the methods herein described may be conducted by the device 500 by means of the data processing unit 510 which runs the program stored in the memory 560 or the read/write memory 550. When the device 500 runs the program, methods herein described are executed.

The foregoing description of the preferred embodiments of the present invention is provided for illustrative and descriptive purposes. It is neither intended to be exhaustive, nor to limit the invention to the variants described. Many modifications and variations will obviously suggest themselves to one skilled in the art. The embodiments have been chosen and described in order to best explain the principles of the invention and their practical applications and thereby make it possible for one skilled in the art to understand the invention for different embodiments and with the various modifications appropriate to the intended use.

It should especially be noted that the system according to the present disclosure can be arranged to perform any of the steps or actions described in relation to the method 300. It should also be understood that the method according to the present disclosure can further comprise any of the actions attributed to an element of the sensor fusion system 299 described in relation to FIG. 2. The same applies to the computer program and the computer program product.

1. A method for improving heat release evaluation at a reciprocating internal combustion engine, the method comprising the steps of:
providing a model regarding volume deviations in at least one combustion chamber based on a first set of dynamic parameters of said combustion engine, wherein said model comprises volume deviations due to thermal changes, due to mass forces and due to pressure forces;
determining said first set of dynamic parameters relating to said combustion engine;
determining said volume deviation in said at least one combustion chamber based on said provided model and based on said first set of determined dynamic parameters;
providing an adaption model for said combustion engine, wherein said adaption model is based on said determined volume deviation in said at least one combustion chamber; and
adapting the combustion engine control and/or a diagnostic system of said combustion engine based on said adaption model so that said heat release evaluation is improved.

2. The method according to claim 1, wherein said provided model regarding volume deviations in said at least one combustion chamber also comprises volume deviations due to the deformation of a cylinder head of said reciprocating combustion engine.

3. The method according to claim 1, wherein said adapting to improve the heat release evaluation relates to adapting at least one parameter related to said heat release evaluation.

4. The method according to claim 1, wherein said first set of dynamic parameters comprises at least one out of the following quantities: crank angle degree, rotary speed of a crankshaft of said combustion engine, temperature of said crankshaft, temperature of at least one connecting rod connected to said crankshaft, temperature of at least one piston connected to said at least one connecting rod, temperature of a cylinder block in said combustion engine, temperature of a cylinder head in the combustion engine, or pressure inside said at least one combustion chamber.

5. The method according to claim 1, wherein said adaption model comprises a relation how the volume deviation relates to at least a second set of dynamic parameters.

6. The method according to claim 5, wherein said second set of dynamic parameters comprises at least one out of the following quantities: a pressure inside said at least one combustion chamber, a temperature of a medium and/or an element, such as temperature of a lubricant and/or oil, temperature of at least one cylinder liner of the combustion engine, temperature of said crankshaft, temperature of said at least one connecting rod, temperature of said at least one piston, crank angle degree, rotary speed of said crankshaft, gas composition in said at least one combustion chamber, whether an inlet valve to a cylinder of said combustion engine is open or closed, or whether an exhaust valve to a cylinder of said combustion engine is open or closed.

7. The method according to claim 1, wherein said adapting of the combustion engine control and/or of said diagnostic system of said combustion engine is performed at at least one pre-determined crankshaft angle and/or at at least one crankshaft angle interval.

8. The method according to claim 1, wherein said adapting of said combustion engine control and/or of said diagnostic system of said combustion engine comprises adaption of at least one out of the following quantities: heat capacity ratio of the gas in said at least one combustion chamber, compression ratio at said combustion engine, or sensitivity of a sensor.

9. The method according to claim 1, wherein said adapting of said combustion engine control and/or of said diagnostic system of said combustion engine comprises adapting at least one quantity such as the heat capacity ratio of the gas in the at least one combustion chamber, and/or the compression ratio at said combustion engine, and/or the sensitivity of a sensor for compensating by said at least one quantity for production tolerances of at least one component of said combustion engine, and/or for compensating by said at least one quantity for wear of at least one component of said combustion engine, and/or by compensating by said at least one quantity for a fuel quality of at least one fuel supplied to the combustion engine.

10. The method according to claim 8, wherein said sensor is a pressure sensor for measuring the pressure in said at least one combustion chamber and/or a knock/acceleration sensor used to determine the pressure in said at least one combustion chamber.

11. The method according to claim 1, wherein said adapting of said combustion engine control and/or of said diagnostic system of said combustion engine comprises adapting at least one maximum volume deviation in said at least one combustion chamber.

12. The method according to claim 1, wherein said method is performed in real time.

13. The method according to claim 1, wherein said adaption of said combustion engine control and/or said diagnostic system of said combustion engine comprises adapting at least one parameter in a particulate matter and/or NOₓ estimation method for said combustion engine.

14. A system for improving heat release evaluation at a reciprocating internal combustion engine, the system comprising:
means for providing a model regarding volume deviations in at least one combustion chamber based on a first set of dynamic parameters of said combustion engine, wherein said model comprises volume deviations due to thermal changes, due to mass forces and due to pressure forces;
means for determining said first set of dynamic parameters relating to said combustion engine;
means for determining said volume deviation in said at least one combustion chamber based on said provided model and based on said first set of determined dynamic parameters;
means for providing an adaption model for said combustion engine, wherein said adaption model is based on said determined volume deviation in said at least one combustion chamber; and
means for adapting the combustion engine control and/or a diagnostic system of said combustion engine based on said adaption model so that said heat release evaluation is improved.

15. The system according to claim 14, wherein said means for adapting said combustion engine control and/or said diagnostic system of said combustion engine are arranged for adapting at least one parameter related to said heat release evaluation.

16. The system according to claim 14, wherein said means for determining said first set of dynamic parameters comprises at least one out of the following means: means for determining a crank angle degree, means for determining a rotary speed of a crankshaft connected to said combustion engine, means for determining the temperature of said crankshaft, means for determining the temperature of at least one connecting rod connected to said crankshaft, means for determining the temperature of at least one piston connected to said at least one connecting rod, means for determining the temperature of a cylinder block in said combustion engine, means for determining the temperature of a cylinder head in said combustion engine, or means for determining the pressure inside said at least one combustion chamber.

17. The system according to claim 14, wherein said means for adapting said combustion engine control and/or of said diagnostic system of said combustion engine are arranged to perform said adaption at at least one pre-determined crankshaft angle and/or at at least one crankshaft angle interval.

18. The system according to claim 14, wherein said means for adapting said combustion engine control and/or of said diagnostic system of the combustion engine are arranged to perform an adaption of at least one out of the following quantities: heat capacity ratio of the gas in said at least one combustion chamber, compression ratio at said combustion engine, or sensitivity of a sensor.

19. The system according to claim 14, wherein said means for adapting said combustion engine control and/or of said diagnostic system of the combustion engine comprise means for adapting at least one quantity such as the heat capacity ratio of the gas in said at least one combustion chamber, the compression ratio at said combustion engine or the sensitivity of a sensor for compensating by said at least one quantity for production tolerances of at least one component of said combustion engine, and/or for compensating by said at least one quantity for wear of at least one component of said combustion engine, and/or by compensating by said at least one quantity for a fuel quality of at least one fuel supplied to said combustion engine.

20. The system according to claim 18, wherein said sensor is a pressure sensor for measuring the pressure in said at least one combustion chamber and/or a knock/acceleration sensor used to determine the pressure in said at least one combustion chamber.

21. The system according to claim 14, wherein said means for adapting said combustion engine control and/or of said diagnostic system of said combustion engine are arranged for adapting at least one maximum volume deviation in said at least one combustion chamber.

22. The system according to claim 14, wherein the system is arranged to perform said adaption in real-time.

23. The system according to claim 14, wherein said means for adapting said combustion engine control and/or said diagnostic system of said combustion engine comprise means for adapting at least one parameter in a particulate matter and/or NOₓ estimation method for said combustion engine.

24. A vehicle, comprising a system for improving heat release evaluation at a reciprocating internal combustion engine, the system comprising:
means for providing a model regarding volume deviations in at least one combustion chamber based on a first set of dynamic parameters of said combustion engine, wherein said model comprises volume deviations due to thermal changes, due to mass forces and due to pressure forces;
means for determining said first set of dynamic parameters relating to said combustion engine;
means for determining said volume deviation in said at least one combustion chamber based on said provided model and based on said first set of determined dynamic parameters;
means for providing an adaption model for said combustion engine, wherein said adaption model is based on said determined volume deviation in said at least one combustion chamber; and
means for adapting the combustion engine control and/or a diagnostic system of said combustion engine based on said adaption model so that said heat release evaluation is improved.

25. (canceled)

26. A computer program product stored on a non-transitory computer-readable medium, said computer program product for improving heat release evaluation at a reciprocating internal combustion engine, when said computer program product comprising computer instructions to cause one or more electronic control units or computers to perform the following operations:
providing a model regarding volume deviations in at least one combustion chamber based on a first set of dynamic parameters of said combustion engine, wherein said model comprises volume deviations due to thermal changes, due to mass forces and due to pressure forces;
determining said first set of dynamic parameters relating to said combustion engine;
determining said volume deviation in said at least one combustion chamber based on said provided model and based on said first set of determined dynamic parameters;
providing an adaption model for said combustion engine, wherein said adaption model is based on said determined volume deviation in said at least one combustion chamber; and
adapting the combustion engine control and/or a diagnostic system of said combustion engine based on said adaption model so that said heat release evaluation is improved.
